(19) United States
(12) Patent Application Publication
(10) Pub. No.: US 2018/0154223 A1
(43) Pub. Date: Jun. 7, 2018

(54) CUSTOMIZABLE LACROSSE HEAD

(71) Applicant: Signature Sidewalls, LLC, Wichita, KS (US)

(72) Inventor: Thomas Patrick McKee, Rapid City, SD (US)

(21) Appl. No.: 15/831,016

(22) Filed: Dec. 4, 2017

Related U.S. Application Data
(60) Provisional application No. 62/429,670, filed on Dec. 2, 2016.

(51) Int. Cl. A63B 49/02; A63B 59/20; B41M 5/382

(52) U.S. Cl. CPC A63B 49/02; A63B 2102/14; B41M 5/382; A63B 59/20

(57) ABSTRACT

A customizable lacrosse head and a method of customizing a lacrosse head are provided. The head includes a head frame having opposed sidewalls extending between a throat and a scoop, each sidewall being capable of customization through machining, cutting, dying, or the like. In some embodiments, the sidewalls include one or more curved and/or angled portion, at least part of such portion being customizable. In some embodiments, the method of customizing the head includes deforming the head frame around a machining block prior to cutting and/or machining the deformed head frame. In some embodiments, the method of customizing the head includes using a press to dye one or more portion of the head frame.

### CROSS-REFERENCE TO RELATED APPLICATIONS

This application claims priority pursuant to 35 U.S.C. 119(e) to co-pending U.S. Provisional Patent Application Ser. No. 62/429,670 filed Dec. 2, 2016, the entire disclosure of which is incorporated herein by reference.

### FIELD OF THE INVENTION

The present invention relates generally to customized sporting equipment. More specifically, the present invention is concerned with a customized lacrosse head and a method of customizing the same.

### BACKGROUND OF THE INVENTION

Lacrosse is a sport with a rich history that is growing in popularity in the United States and around the world. In fact, in recent years it has been one of the fastest growing sports in the United States, providing a variety of recreational and competitive opportunities for boys, girls, men, and women.

Lacrosse is sport in which two teams compete against each other on a field separating opposed goals. Each team is assigned a goal to defend. The object of the game is to advance a ball to the opponents goal while preventing your opponent from advancing the ball to your goal. Each player has a stick, which is used for catching, carrying, passing, and shooting the ball. A stick can also be used to strike an opponent's stick and/or gloves so as to disrupt the opponent's attempts to catch, carry, pass, or shoot the ball.

A stick includes a head coupled to a shaft. A first portion of the head is configured to hold a ball while a player is running, thereby allowing the player to carry the ball. A second portion of the head is wider than the first portion, the second portion being configured for scooping the ball, receiving the ball, and throwing the ball. A sidewall extends between the first and second portions on each side of the head.

While lacrosse heads are often required to meet certain requirements, such as sizing requirements, manufacturers have developed designs to distinguish their various products from each other and/or from their competitor's products. For instance, U.S. Design Pat. No. D496,083, the entire disclosure of which is incorporated herein by reference, teaches an ornamental design for a lacrosse head sidewall silhouette. Furthermore, players often desire to personalize their lacrosse heads so as to convey a message, reflect the player's personality, and/or to distinguish the player's lacrosse head from other players' lacrosse heads, thereby enabling players to more quickly determine which lacrosse stick is theirs. Unfortunately, current products and techniques provide limited ability for individuals to personalize their lacrosse heads without expending significant resources and/or waiting a significant amount of time. Consequently, it would be beneficial to have a system for and a method of personalizing lacrosse heads that is quick, easy, and inexpensive.

### SUMMARY OF THE INVENTION

The present invention comprises a personalized lacrosse head and a method of personalizing lacrosse heads and fabricating personalized lacrosse heads. In some embodiments, machining and/or dying techniques are utilized to personalize one or more portion of a lacrosse head.

Lacrosse heads of the present invention include proximal and distal ends and opposed sidewalls extending therebetween. In some embodiments, the sidewalls include one or more curved region, angle, and/or other transition. In some embodiments, at least one portion of one or more sidewall is formed from a machinable material. In some embodiments, at least some of the material of the head frame is susceptible to dying and/or other coloration techniques.

The present invention provides many advantages over the prior art. For instance, the present invention allows users to customize a single lacrosse head frame to meet a specific user's specifications without requiring creation of a unique injection mold. Furthermore, the present invention enables users to quickly and easily incorporate features into a lacrosse head frame, some such features being difficult or impossible to implement into the head frame during the injection molding process.

In some embodiments, the process includes using a CNC process in conjunction with a dye process to create designs that are not limited to solely the inner portion of a sidewall (reference FIG. 8B). In some such embodiments, the designs are unrecognizable without the use of the two processes (reference FIG. 8A). In some embodiments, the dye process includes masking different areas with vinyl decals and glue.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is an isometric view of a lacrosse head frame of the current invention.

FIG. 2 is a side view of the lacrosse head frame of FIG. 1.

FIG. 3 is a top view of a head frame of the present invention displaced from a machining block of the present invention.

FIG. 4 is a top view of the head frame of FIG. 3 stretched around the machining block of FIG. 3.

FIG. 5 is a front view of a machining process for a head frame of the present invention.

FIG. 6 is a front view of a machining process for a head frame stretched around a machining block.

FIG. 7A is an isometric view of a head frame of the present invention.

FIG. 7B is an isometric view of a head frame of the present invention.

FIG. 7C is an isometric view of a head frame of the present invention.

FIG. 8A is a machined head without dye.

FIG. 8B is the machined head of FIG. 8A with dye.

FIG. 9A is a machined head having a design with photo-quality detail.

FIG. 9B is a lacrosse head having a design with dye.

FIG. 9C is a lacrosse head having a design with dye.

FIG. 10A is a side view of a blank lacrosse head.

FIG. 10B is a top view of the blank lacrosse head of FIG. 10A.

FIG. 10C is an inverted side view of a machined lacrosse head.

FIG. 10D is a bottom isometric view of the machined lacrosse head of FIG. 10C.

FIG. 10E is an isometric view of a machined lacrosse head.

FIG. 11 is an isometric view of a flat heat press for use with a dye process.

FIG. 11A shows a step of using the flat heat press of FIG. 11 in a dye process.

FIG. 11B shows a step of using the flat heat press of FIG. 11 in a dye process.

FIG. 11C shows a step of using the flat heat press of FIG. 11 in a dye process.

FIG. 11D is a graphic representation of a stack-up of materials of a dye process.

FIG. 11E is a graphic representation of a stack-up of materials of a dye process.

FIG. 12 is an isometric view of a custom metal plate for use with a dye process.

FIG. 13 shows a side view of a base head and four machined heads, two of the machined heads having been previously dyed.

FIG. 14 shows a side view of a base head and two machined heads.

FIG. 15 shows isometric views of two machined heads, one of the machined heads having been previously dyed.

FIG. 16 shows isometric views of two machined heads, one of the machined heads having been previously dyed.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

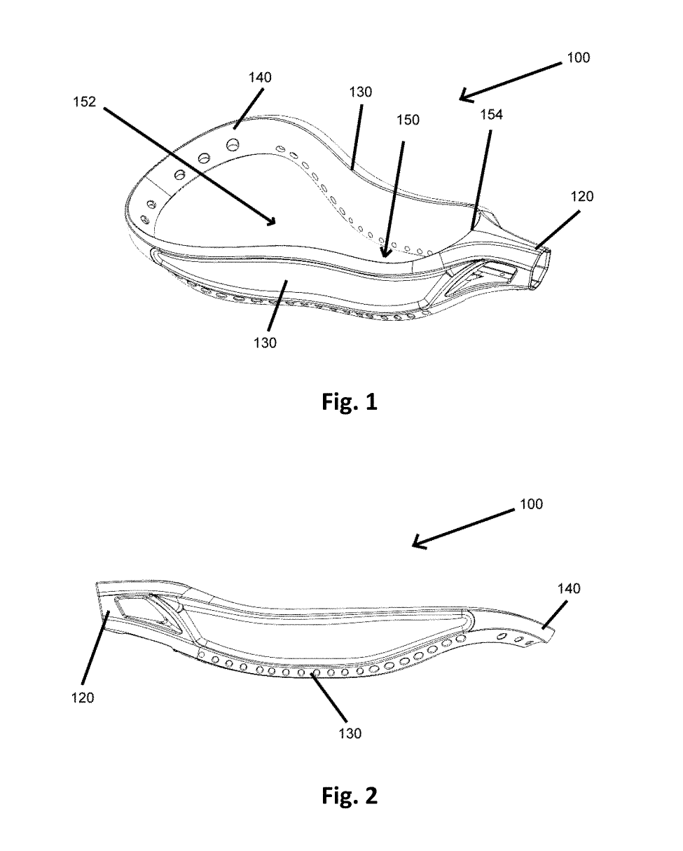

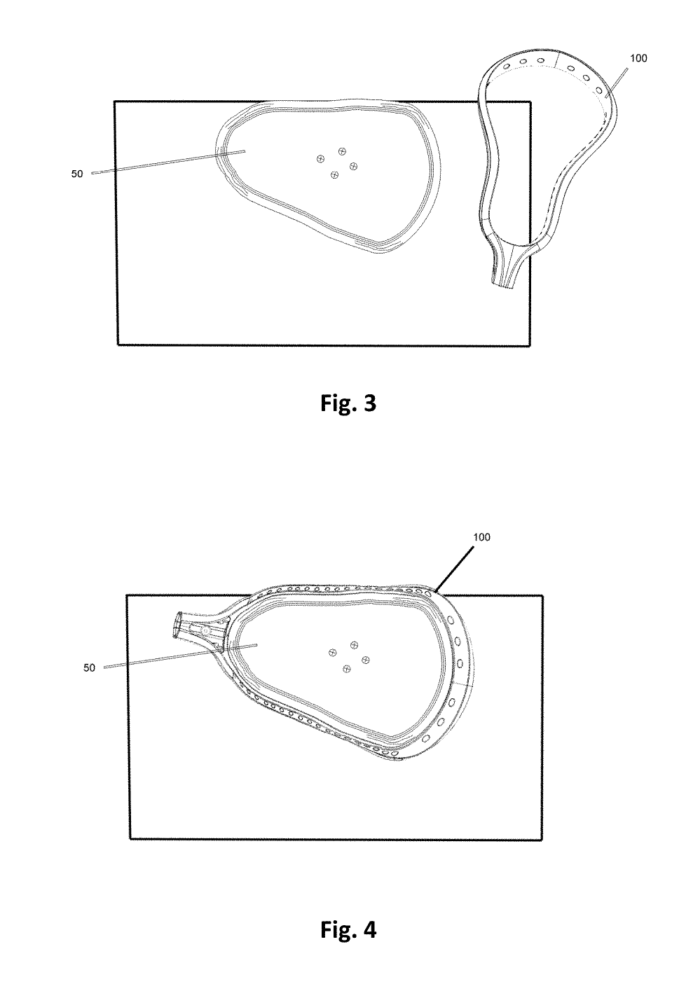

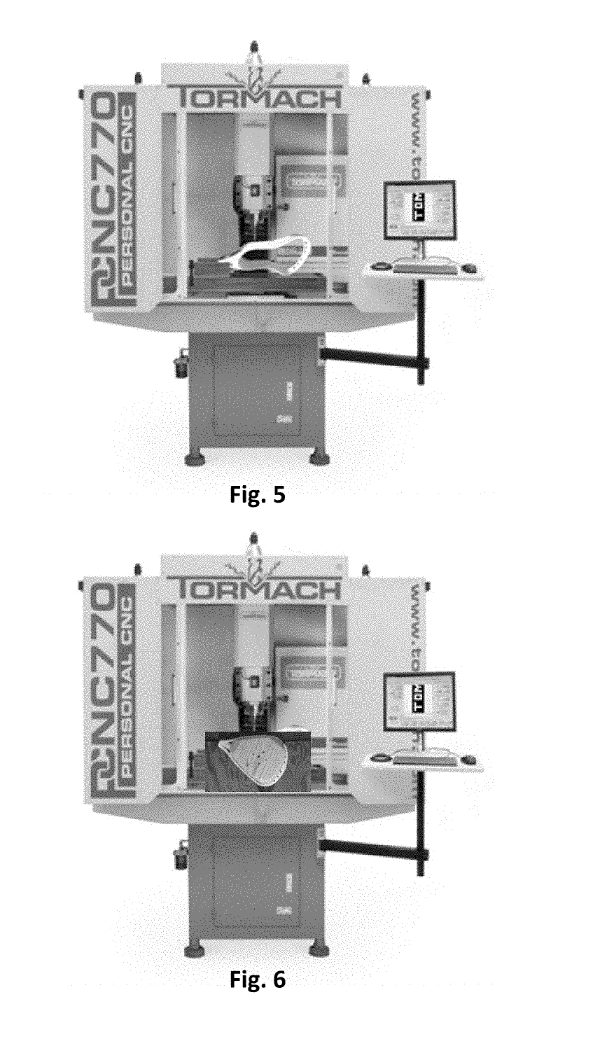

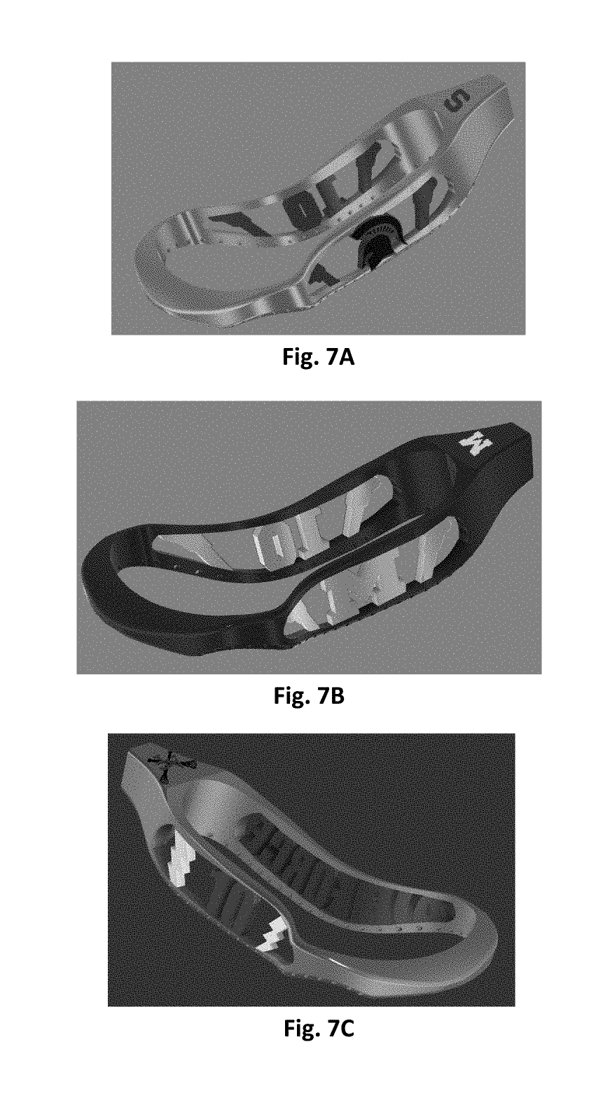

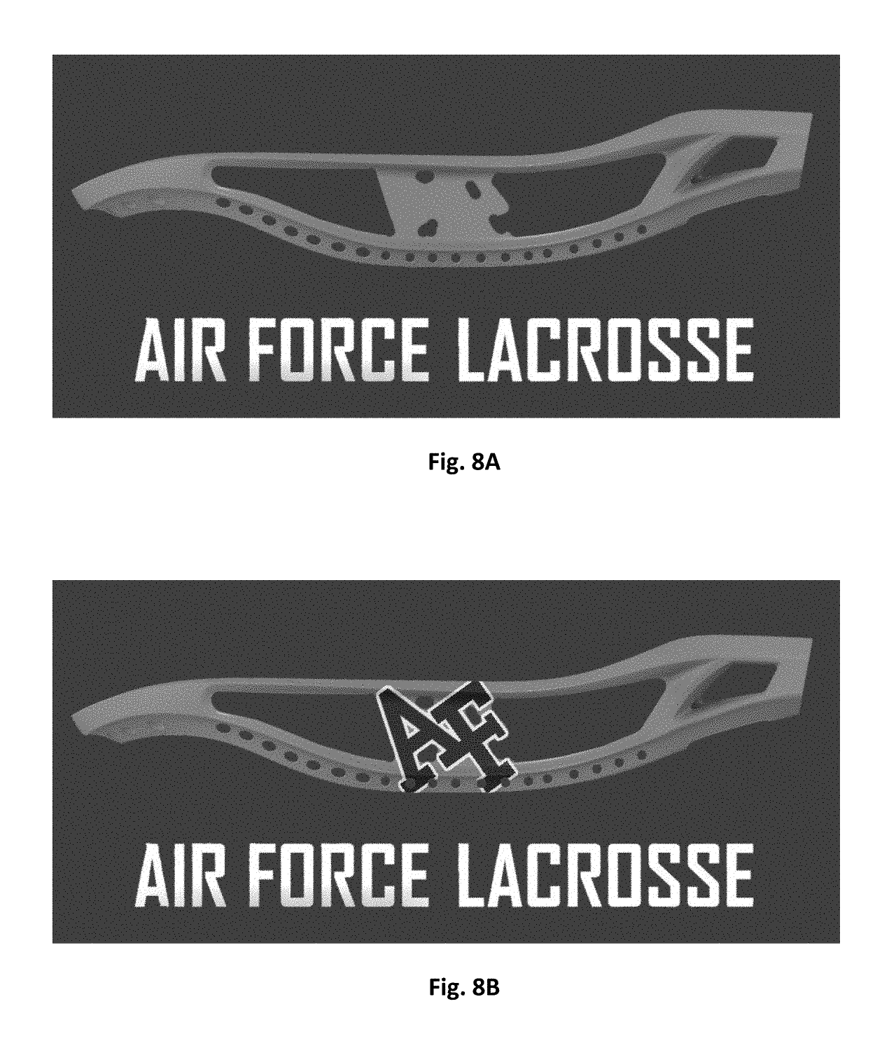

Referring to FIG. 1, lacrosse heads of the present invention include a head frame 100 having proximal and distal ends and opposed sidewalls 130 extending therebetween. In some embodiments, the proximal end of the head frame 100 includes a throat 120 that is configured to selectively couple to a distal end of a shaft 20, thereby enabling the lacrosse head to be utilized in a lacrosse game. In some embodiments, the distal end of the head frame 100 defines a scoop 140, thereby enabling a player to scoop, receive, and/or throw a lacrosse ball.

In some embodiments, a first portion of the sidewalls 130 extend from the throat 120 towards the distal end of the head frame 100. In some embodiments, a second portion of the sidewalls 130 extend from the scoop 140 towards the proximal end of the head frame 100. In some embodiments, the second portion of each sidewall 130 extends to a distal end of a respective first portion of each sidewall, thereby defining respective sidewalls 130 of the head frame 100.

In some embodiments, respective first portions of the sidewalls 130 define a raceway 150 extending between an opening 152 at a distal end of the first portions of the sidewalls 130 and a stop 154 positioned at or near a proximal end of the sidewalls 130. In some embodiments, the stop 154 is defined by one or more radius. The raceway 150 defines a first interior width at the opening 152 and a second interior width adjacent to the stop 154. In some embodiments, the first portion of each sidewall 130 is generally parallel with the first portion of the opposed sidewall 130 such that the first and second interior widths are approximately equivalent to each other.

In some embodiments, the second portion of each sidewall 130 is configured to direct a lacrosse ball towards the opening 152 of the raceway 150, thereby directing the lacrosse ball into relationship with the raceway 150 and towards the stop 154 of the raceway 150. In some embodiments, a proximal end of each second portion of each sidewall 130 defines an interior width that is generally equivalent to the width of the opening 152 of the raceway 150 so as to accommodate movement of the lacrosse ball into the raceway 150. In some embodiments, a distal end of each second portion of each sidewall 130 defines an interior width that is generally equivalent to a width of the scoop 140 so as to accommodate movement of the lacrosse ball from the scoop 140 towards the raceway 150 and/or from the raceway 150 towards the scoop 140.

In some embodiments, the width of the scoop 140 is larger than a diameter of the lacrosse ball so as to accommodate scooping and receiving the lacrosse ball. In some embodiments, the width of a portion of the raceway 150 is slightly larger than a width of a respective portion of the lacrosse ball so as to accommodate the lacrosse ball moving between the opening 152 of the raceway 150 and the stop 154 of the raceway 150. In some embodiments, the width of a portion of the raceway 150 is slightly smaller than a width of a respective portion of a lacrosse ball so as to accommodate securing the lacrosse ball between the head frame 100 and a net 200 coupled to the head frame 100. In some embodiments, the width of the scoop 140 is larger than the width of the raceway 150 such that at least a portion of each sidewall 130 is angled inward towards the opposed sidewall 130.

In some embodiments, the sidewalls 130 include one or more curved region. In some embodiments, the sidewalls 130 include one or more angle, such as at a transition between the first and second portions of the sidewalls 130. In some embodiments the angle is less than ninety (90) degrees such that an exterior surface of each sidewall 130 generally defines an open angle between approximately one-hundred forty (140) degrees and one-hundred sixty (160) degrees.

In preferred embodiments, at least one sidewall 130 includes a solid portion. In some embodiments, the solid portion is formed from a machinable material. In some embodiments, the head frame 100 is configured so as to accommodate machining of the solid portion of the head frame 100. In some embodiments, the head frame 100 is formed, at least in part, from a flexible material. In some embodiments, the head frame 100 is an injection molded head frame 100.

In some embodiments, each sidewall 130 is formed, at least in part, from one or more slide. In some embodiments, each slide is coupled to a respective side of the head frame 100 so as to form a sidewall 130 of the head frame 100. In some embodiments, the slide includes one or more feature for interfacing with the head frame 100. In some embodiments, each slide includes one or more feature for interfacing with one or more machining tool. In some embodiments, the head frame 100 includes one or more feature for enabling the sidewalls 130 of the head frame 100 to be machined post-production. In this way, the head frame 100 is customizable. In some embodiments, at least some of the material of the head frame 100 is susceptible to dying and/or other coloration techniques so as to further customize the head frame 100.

The present invention further includes a method of fabricating a head frame 100 for a lacrosse head. In some embodiments, the method includes coupling a slide to a side of the head frame 100 so as to form a sidewall 130 of the head frame 100. In some embodiments, the method further includes forming the slide with one or more feature and/or machining one or more feature into the slide. In some embodiments, the one or more feature is a customization feature.

The present invention further includes a method of personalizing a lacrosse head. In some embodiments, the method includes machining a sidewall 130 of a head frame 100. In some embodiments, the method includes dying at least part of the head frame 100, such as the sidewall 130. In some embodiments, the method includes protecting at least part of the head frame 100 during a dying process, such as a sidewall 130 of the head frame 100, so as to prevent such protected area from becoming dyed. In some embodiments, the method includes dying at least part of the head frame 100 prior to machining at least part of the head frame 100, thereby exposing material that is void of dye.

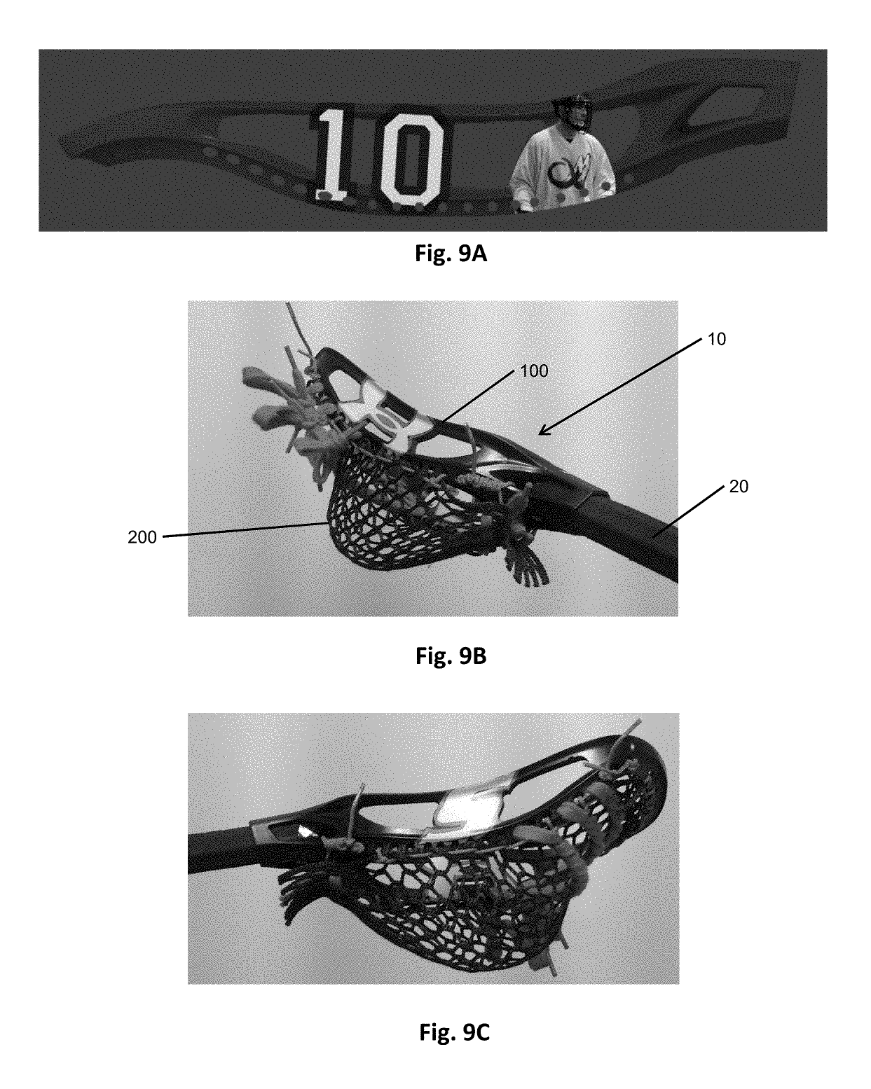

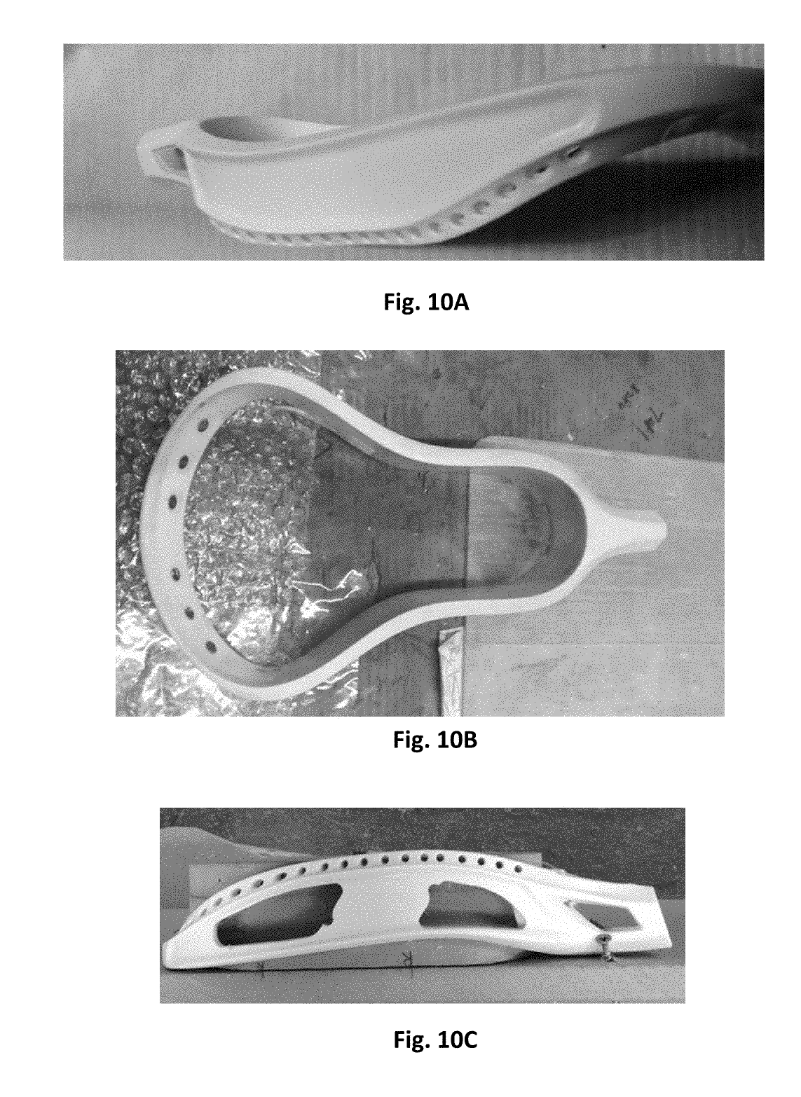

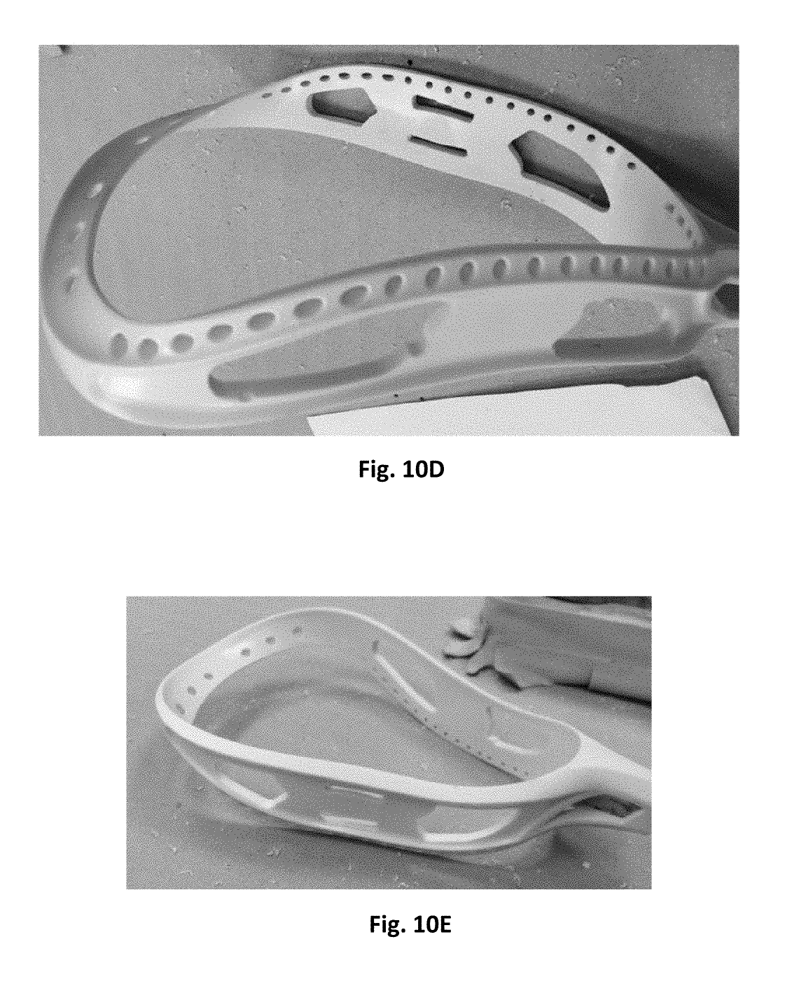

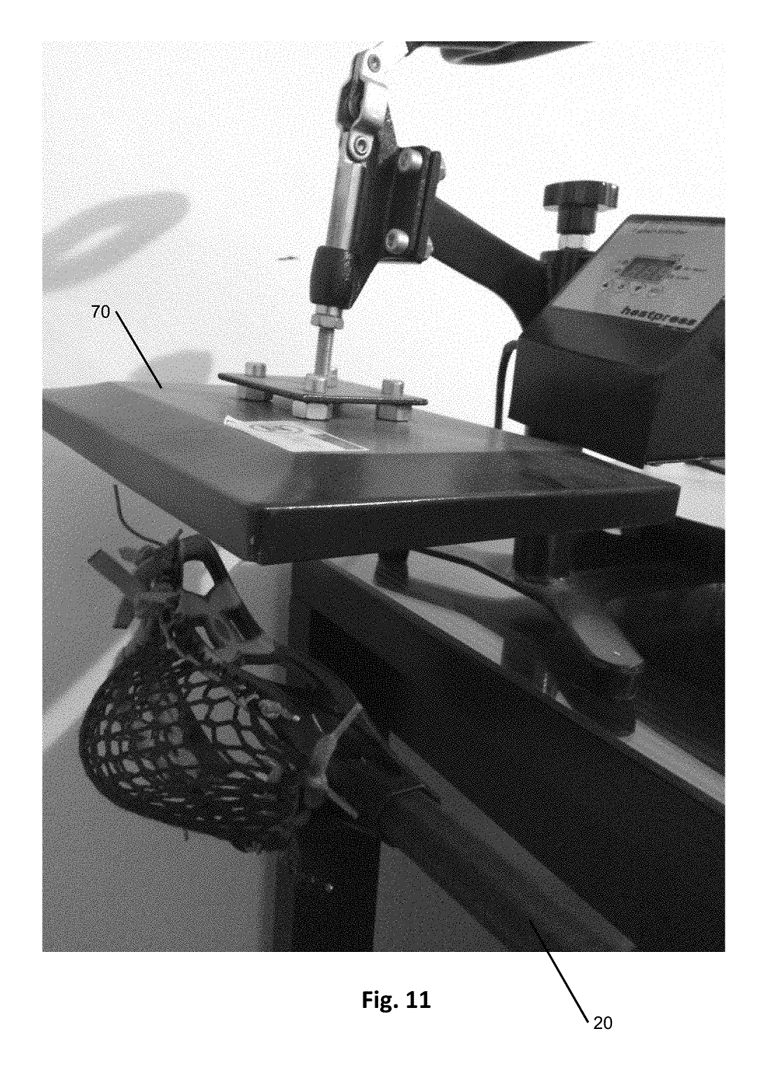

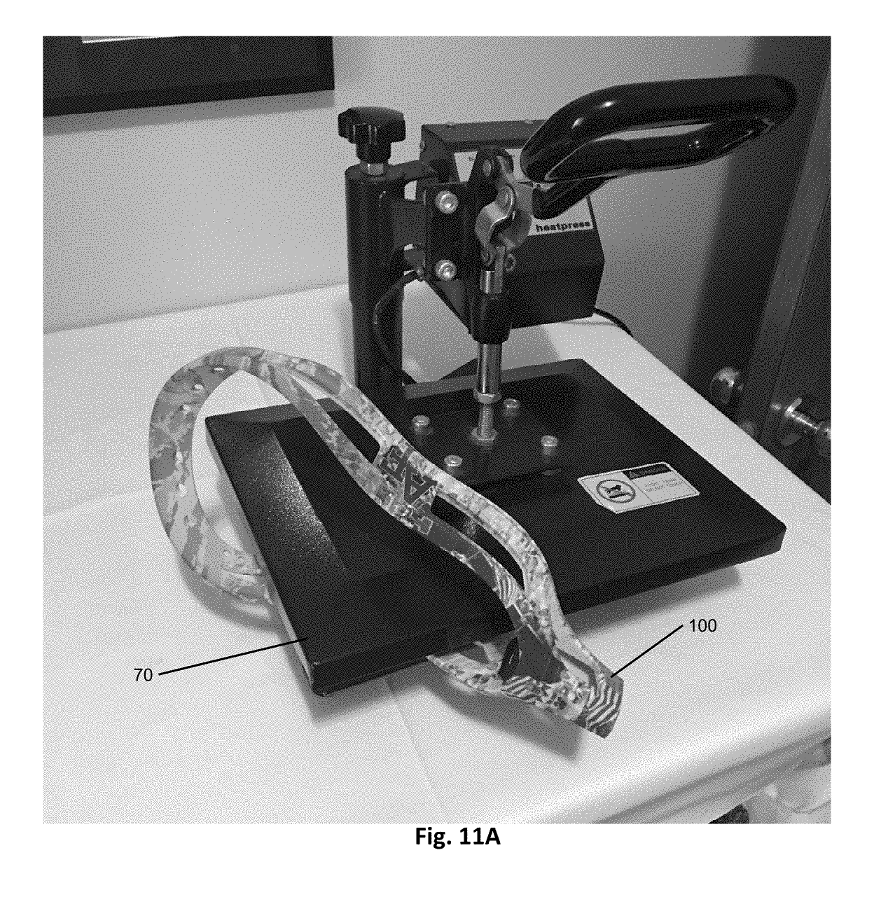

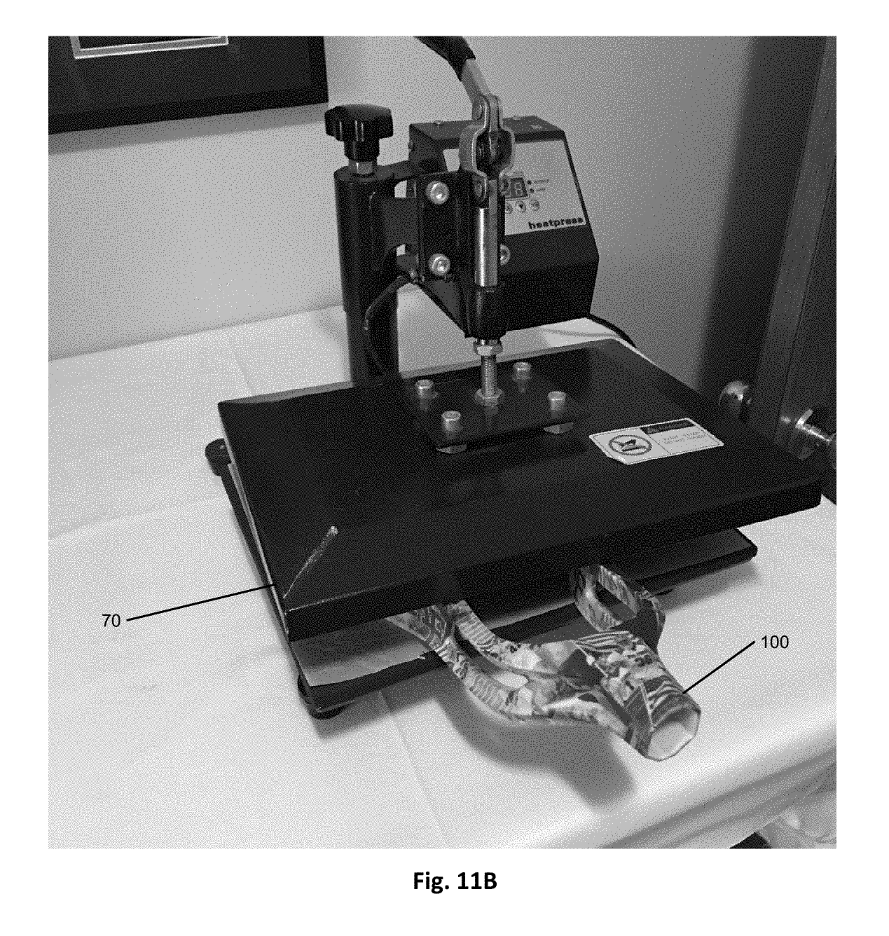

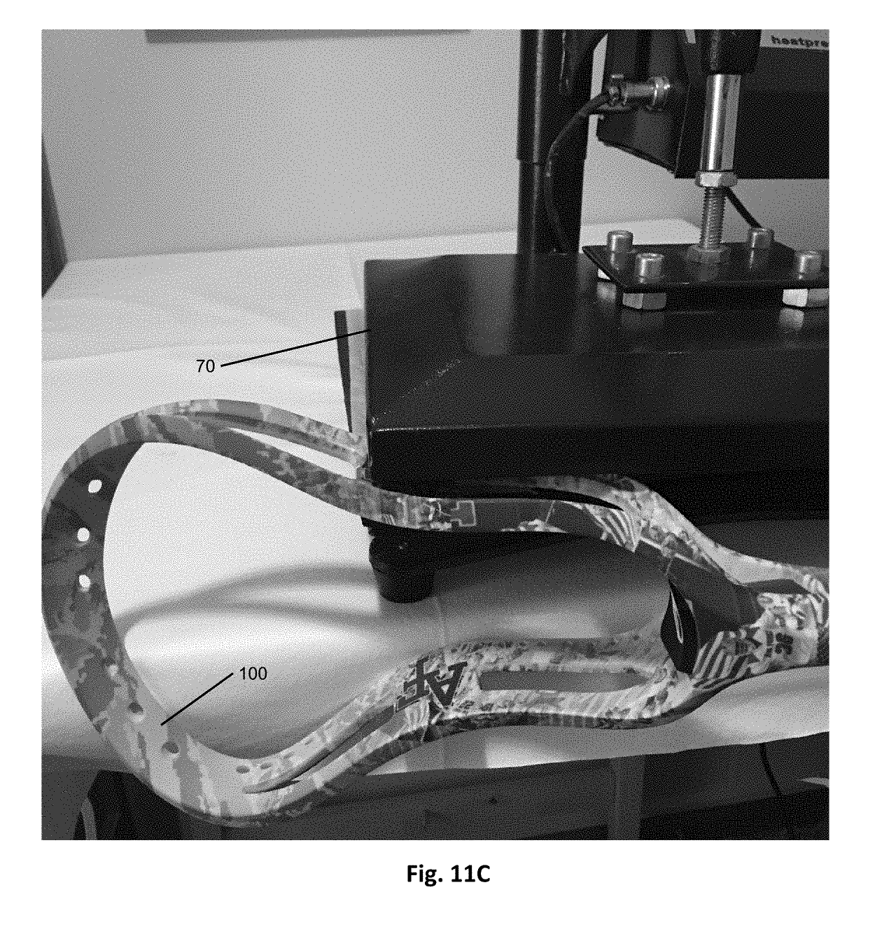

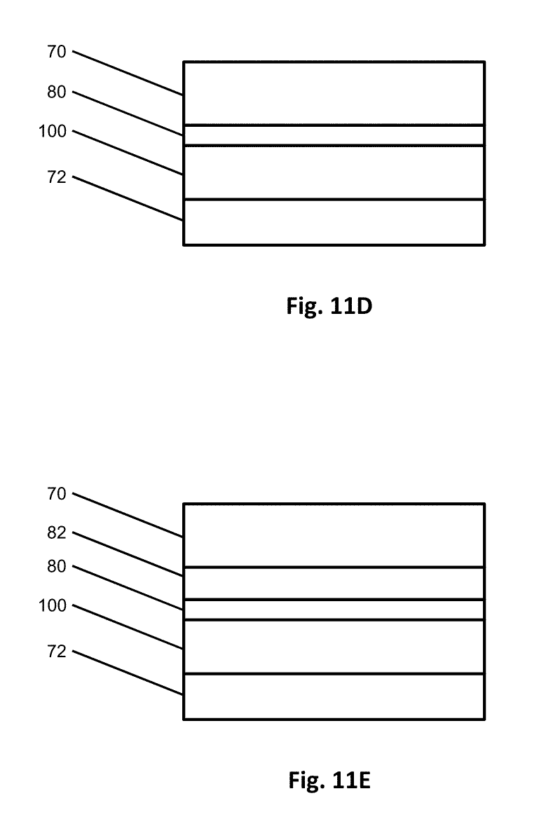

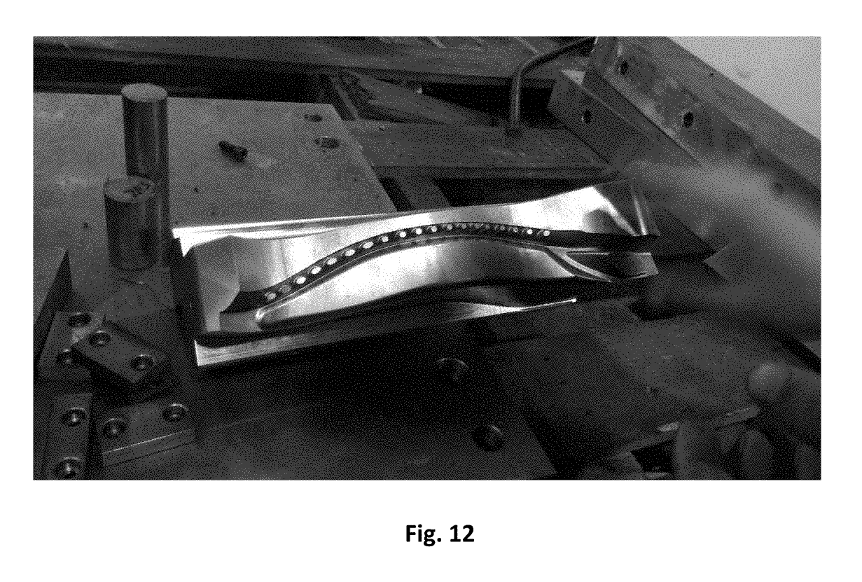

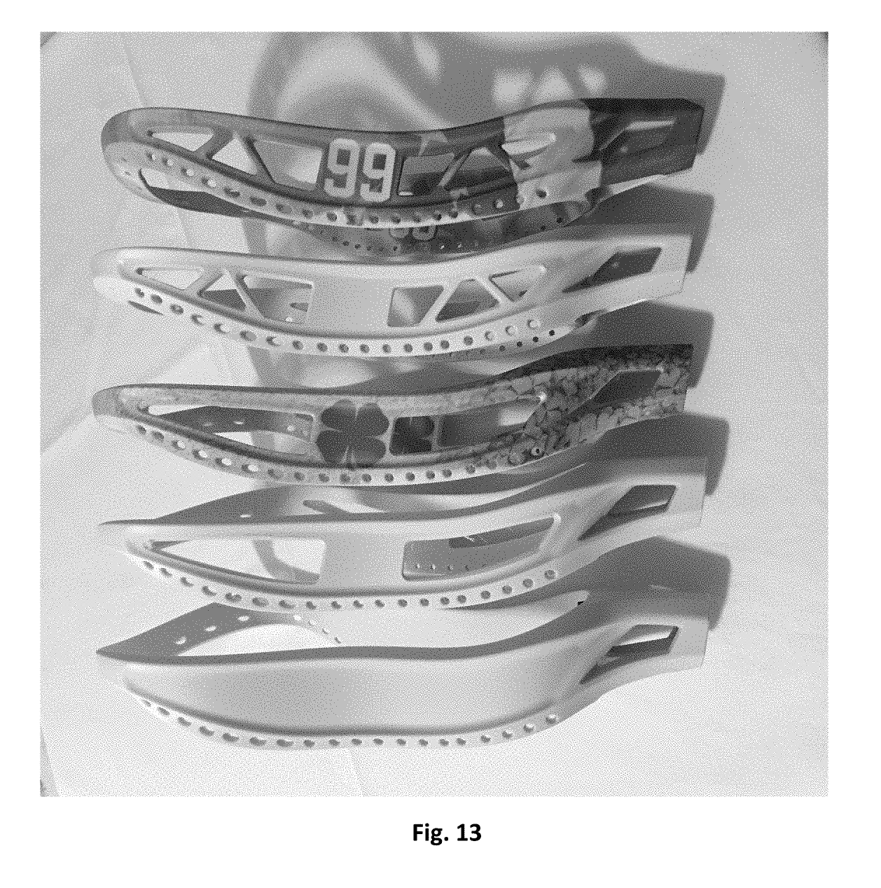

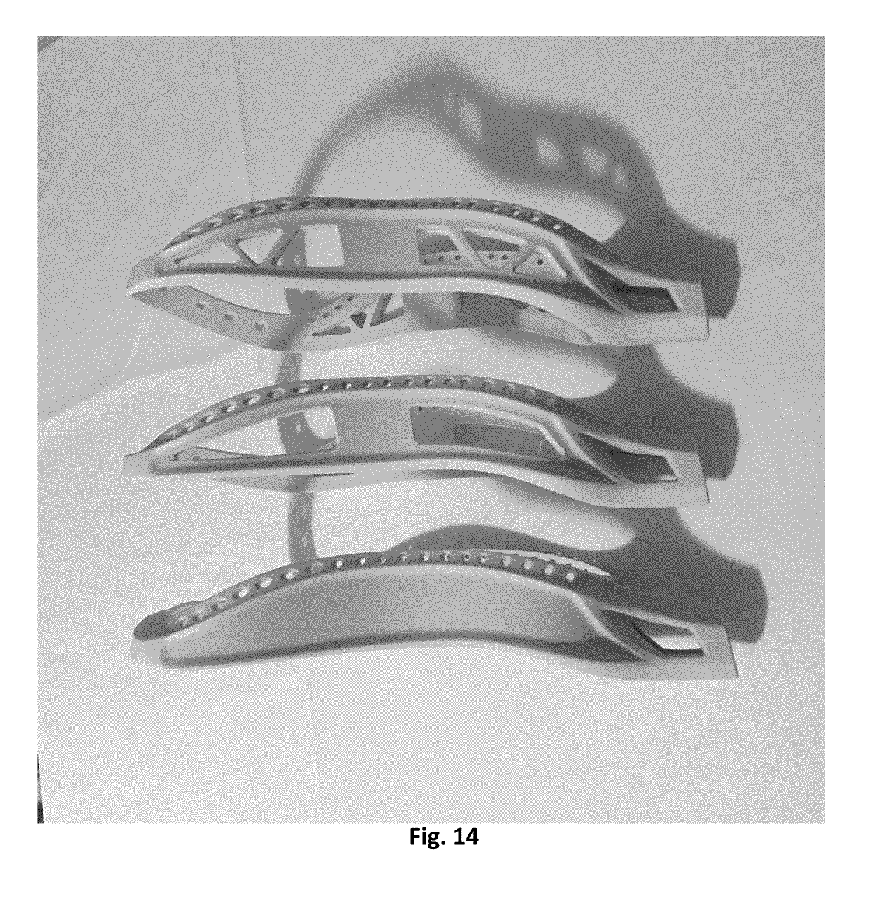

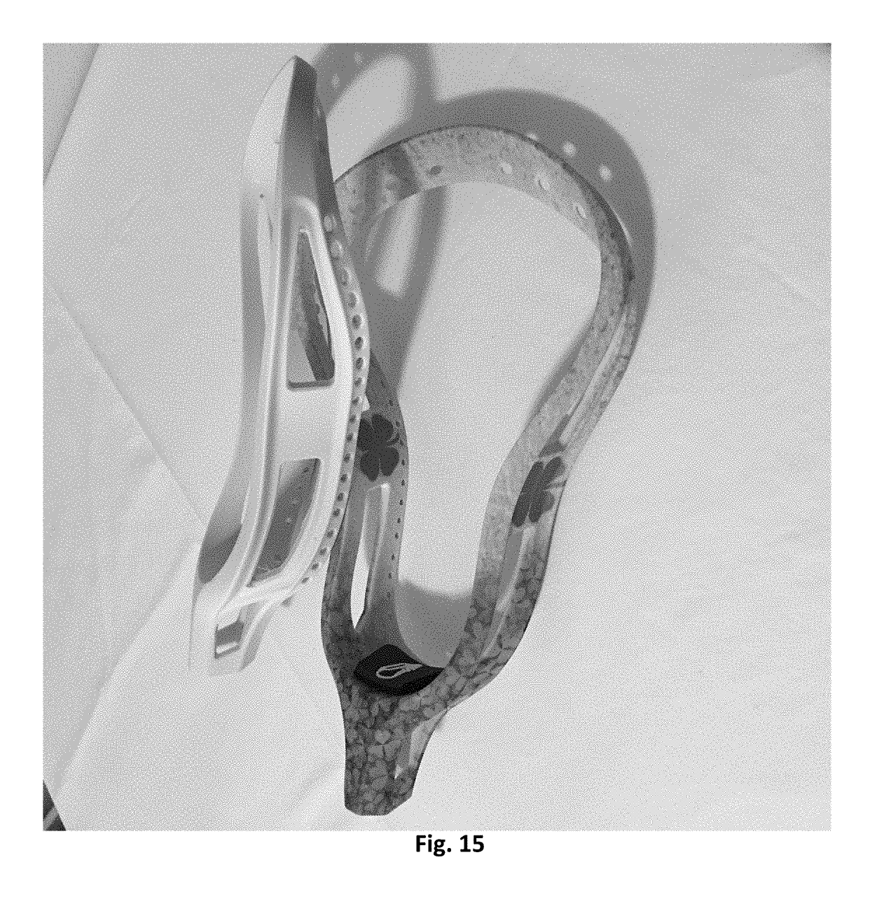

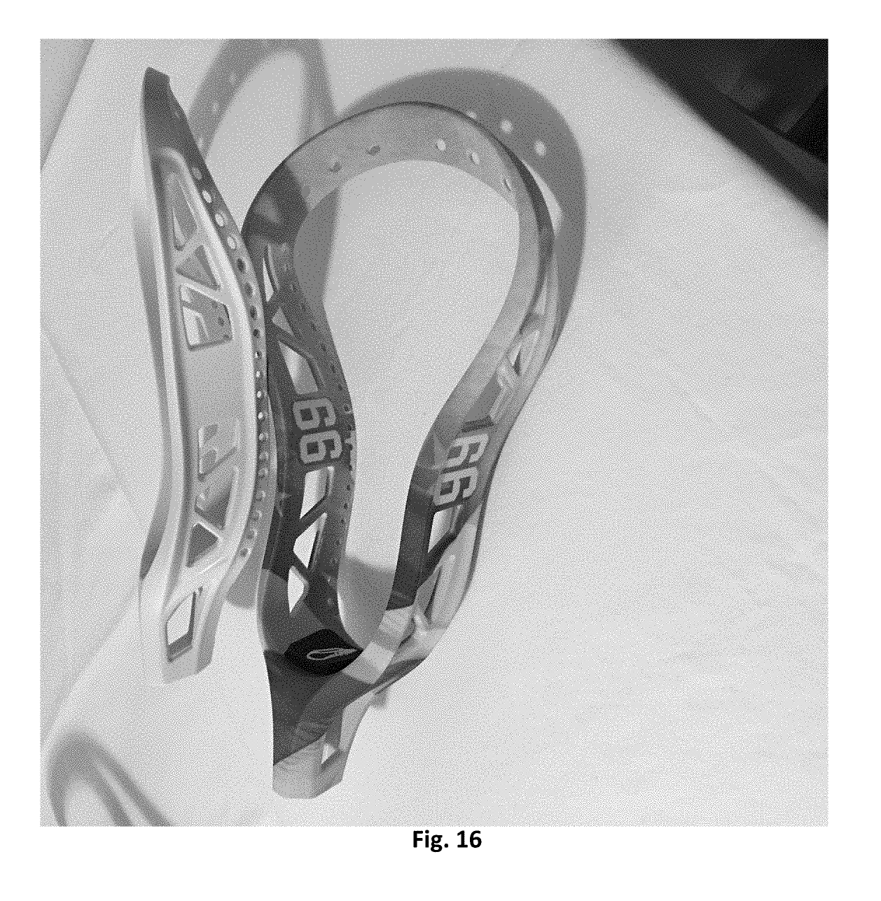

In some embodiments, the dye process is a dye sublimation process. In some embodiments, a design is virtually printed onto special transfer paper and then heat and pressure is used to infuse that dye into the plastic material of the lacrosse head frame. Referencing FIG. 9A, some such processes produce designs with photo quality detail. Referencing FIG. 11, some embodiments of dye sublimation utilize a flat heat press 70 with heat conductive rubber pads. Referencing FIG. 12, some embodiments of dye sublimation utilize a custom metal plate that follows one or more curve or contour of the head frame 100, such as one or more curve or contour of a sidewall 130 of the head frame 100. Some embodiments of dye sublimation utilize a technique involving a rubber vacuum bag that encapsulates the head frame 100 prior to it being placed in a 3D sublimation machine to transfer the dye to the head frame.

Referring to FIG. 11D, some embodiments of the dye process include placing a portion of a head 100 between a heat press 70 and a bottom plate 72 such that biasing the heat press 70 towards the bottom plate 72 with the head 100 positioned therebetween creates pressure on one or more surface of the head 100. In some embodiments, a transfer sheet 80 is positioned directly between the heat press 70 and the head 100, thereby causing the transfer sheet 80 to be pressed against the head 100 while being heated by the heat press 70.

Referring to FIG. 11E, some embodiments of the dye process include placing an intermediate layer 82 between the heat press 70 and the transfer paper 80. In some embodiments, the intermediate layer is configured to flow around one or more curve and/or into one or more contour of the head 100, thereby causing the transfer paper to do the same. In this way, dye from the transfer paper is more uniformly distributed across such areas of the head 100. In some embodiments, the intermediate layer is configured so as to provide a more uniform heat flow from the heat press 70 to the head 100 and/or to provide more uniform pressure on one or more surface of the head 100.

In some embodiments, the intermediate layer 82 is formed from thin, malleable sheets of material, such as aluminum foil. In some embodiments, the dying process includes bending, bunching, rolling, or otherwise forming a portion of the intermediate layer 82 and positioning such portion of the intermediate layer 82 between the heat press 70 and a recessed area of the head so that such portion of the intermediate layer 82 will fill at least part of such recess, thereby increasing pressure to and/or heat transfer to such recess. In some embodiments, the dying process includes bending one or more portion of the intermediate layer 82 around one or more curve, lip, or other feature of the head 100 so as to affix the intermediate layer 82 to the head 100, so as to hold the transfer sheet 80 in position relative to the head 100, and/or to increase pressure on and/or heat transfer to such feature.

In preferred embodiments, the sidewall 130 is a solid sidewall 130. In some embodiments, the sidewall 130 includes one or more curve and/or angle, such as a curve and/or angle associated with a transition between first and second portions of a sidewall 130 of the head frame 100. In some embodiments, the head frame 100 is deformed around a machining block 50 prior to machining. In some embodiments, deforming the head frame 100 around a machining block 50 causes at least one sidewall 130 to straighten and/or otherwise deform so as to allow the sidewall 130 to be machined using a three-axis machine, a laser cutter, a handheld cutting tool, or one of the many cutting methods now known or later developed. In this way, a user is able to quickly and easily customize the sidewall 130 without requiring a four-axis machine and/or complicated machining techniques. Upon completion of the machining and/or cutting process, the machining block 50 is removed so as to allow the head frame 100 to return to its normal shape, the head frame 100 now being customized.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of personalizing a frame for a lacrosse head, the method comprising:
deforming the frame about a machining block so as to deform a sidewall of the frame;
machining the deformed sidewall; and
removing the frame from the machining block, thereby allowing the sidewall to return to its undeformed shape.

2. The method of claim 1, wherein the undeformed shape of the sidewall comprises a transition defined by at least one of an angle or a curve.

3. The method of claim 2, wherein deforming the frame about the machining block causes the transition of the sidewall to be generally straight, thereby providing for a generally flat machining surface.

4. The method of claim 3, further comprising a dying process.

5. The method of claim 4, wherein the dying process is a sublimation process.

6. The method of claim 4, wherein the dying process comprises:
moving at least one of a transfer paper or the frame into contract with each other, the transfer paper including at least one design printed thereon;
utilizing at least one of heat and pressure to transfer at least part of the design from the transfer paper onto at least a portion of the frame.

7. The method of claim 6, wherein the dying process causes at least some of the dye from the transfer paper to be infused into the material of the frame.

8. The method of claim 6, wherein the dying process utilizes a heat press to generate heat and pressure for transferring at least part of the design from the transfer paper onto at least a portion of the frame, an intermediate layer positioned between the transfer paper and the heat press being configured to perform at least one of holding the transfer paper in position relative to the head, increasing pressure in one or more recessed area of the head, and increasing heat transfer to one or more feature of the head.

9. The method of claim 8, wherein the dying process causes at least some of the dye from the transfer paper to be infused into the material of the frame.

10. The method of claim 6, wherein the dying process further comprises protecting at least part of the frame so as to prevent dye from being infused with such protected portion during the dying process.

11. The method of claim 6, wherein the dying process further comprises deforming the frame.

12. A method of personalizing a frame for a lacrosse head, the method comprising:
deforming a sidewall of the frame as part of a dying process;
moving at least one of a transfer paper or the frame into contract with each other, the transfer paper including at least one design printed thereon;
utilizing at least one of heat and pressure to transfer at least part of the design from the transfer paper onto at least a portion of the frame.

13. The method of claim 12, wherein the undeformed shape of the sidewall comprises a transition defined by at least one of an angle or a curve.

14. The method of claim 13, wherein deforming the frame as part of the dying process causes the transition of the sidewall to be generally straight, thereby providing for a generally flat dying surface.

15. The method of claim 14, wherein the dying process further comprises protecting at least part of the frame so as to prevent dye from being infused with such protected portion during the dying process.

16. The method of claim 14, wherein the dying process is a sublimation process.

17. The method of claim 14, wherein the dying process causes at least some of the dye from the transfer paper to be infused into the material of the frame.

18. The method of claim 14, wherein the dying process utilizes a heat press to generate heat and pressure for transferring at least part of the design from the transfer paper onto at least a portion of the frame, an intermediate layer positioned between the transfer paper and the heat press being configured to perform at least one of holding the transfer paper in position relative to the head, increasing pressure in one or more recessed area of the head, and increasing heat transfer to one or more feature of the head.

19. The method of claim 18, wherein the dying process causes at least some of the dye from the transfer paper to be infused into the material of the frame.

20. The method of claim 19, wherein the dying process further comprises protecting at least part of the frame so as to prevent dye from being infused with such protected portion during the dying process.
